(19) United States
(12) Patent Application Publication
(10) Pub. No.: US 2026/0137216 A1
(43) Pub. Date: May 21, 2026

(54) BACKREST FOLDING ASSEMBLY AND SEATING EQUIPMENT

(71) Applicant: JASON FURNITURE (HANGZHOU) CO., LTD., Hangzhou (CN)

(72) Inventors: Ping WANG, Hangzhou (CN); Bingchao FENG, Hangzhou (CN); Linlin WU, Hangzhou (CN); Jizhong CAO, Hangzhou (CN)

(21) Appl. No.: 19/073,638

(22) Filed: Mar. 7, 2025

(30) Foreign Application Priority Data
Nov. 20, 2024 (CN) 202411672422.3

(51) Int. Cl. A47C 7/54; A47C 7/40; A47C 7/62; F16C 11/04; F16M 13/02

(52) U.S. Cl. CPC A47C 7/543; A47C 7/40; A47C 7/624; F16C 11/04; F16M 13/022

(57) ABSTRACT

The present disclosure provides a backrest folding assembly and a seating equipment. The backrest folding assembly includes a fixing piece, an upper linkage rod, a lower linkage rod, a fixing piece for a folding plate, a middle linkage rod and a protection plate. An end of each of the upper linkage rod and the lower linkage rod is rotatably connected with the fixing piece respectively, and the other end of each of the upper linkage rod and the lower linkage rod is rotatably connected with the fixing piece for the folding plate respectively; the middle linkage rod is rotatably connected with the lower linkage rod, and the protection plate is rotatably connected with the upper linkage rod and the middle linkage rod respectively.

### CROSS REFERENCE TO RELATED APPLICATIONS

This application claims priority to Chinese Patent Application No. 202411672422.3 filed on Nov. 20, 2024, the entire content of which is incorporated herein by reference.

### TECHNICAL FIELD

The present disclosure relates to the field of seating equipment and in particular to a backrest folding assembly and a seating equipment.

### BACKGROUND

Various types of seating equipment exist on markets. The seating equipment may include sofas, beds, chairs, office chairs or other types of furniture provided for rest. For traditional seating equipment, a backrest and a folding plate are fixedly connected simply, which does not allow for folding or angle adjustment. This limits their usage scenarios and occupies large space. In existing seating equipment, a hydraulic system or electric system is applied to realize folding of a backrest folding assembly of the seating equipment. But these designs make the backrest folding assembly structurally complicated and have many parts, leading to high manufacturing costs. Furthermore, no protection plate is provided on the backrest folding assembly of the seating equipment. During a folding process, the backrest and the folding plate may pinch users, leading to low safety.

Therefore, it is necessary to provide an improved backrest folding assembly and seating equipment, so as to solve the above problems.

### SUMMARY

The present disclosure provides a low-cost and high-safety backrest folding assembly and seating equipment.

The present disclosure provides a backrest folding assembly, which includes a fixing piece, an upper linkage rod, a lower linkage rod, a fixing piece for a folding plate, a middle linkage rod and a protection plate. An end of each of the upper linkage rod and the lower linkage rod is rotatably connected with the fixing piece respectively, and the other end of each of the upper linkage rod and the lower linkage rod is rotatably connected with the fixing piece for the folding plate respectively. The middle linkage rod is rotatably connected with the lower linkage rod, and the protection plate is rotatably connected with the upper linkage rod and the middle linkage rod respectively.

Furthermore, the protection plate and the fixing piece for the folding plate are located at inner and outer sides of the upper linkage rod and the lower linkage rod respectively, and the protection plate and the fixing piece for the folding plate are same in folding direction.

Furthermore, when the backrest folding assembly is unfolded, bottoms of the fixing piece for the folding plate and the protection plate are lifted and moved close to the fixing piece, and tops of the fixing piece for the folding plate and the protection plate are lifted and moved away from the fixing piece.

Furthermore, the protection plate is constructed to cover a gap enclosed by the upper linkage rod, the lower linkage rod and the fixing piece for the folding plate when the backrest folding assembly is unfolded or folded.

Furthermore, the protection plate includes a top edge, a first side edge, a bottom edge and a second side edge connected sequentially. The top edge is opposed to the bottom edge, and the first side edge is opposed to the second side edge. A length of the bottom edge is greater than a length of the top edge.

Furthermore, when the backrest folding assembly is unfolded, the first side edge is flush with an upper edge of the upper linkage rod; the second side edge is below the upper linkage rod; the bottom edge is located before the fixing piece; the protection plate covers an upper part of the lower linkage rod. When the backrest folding assembly is folded up, the first side edge is located before the fixing piece, and the first side edge and the second side edge are respectively located at both sides of the upper linkage rod; the protection plate covers the fixing piece for the folding plate.

Furthermore, the protection plate includes a first fixing portion, a second fixing portion, and a first bending portion connecting the first fixing portion and the second fixing portion. The first fixing portion is rotatably connected to the upper linkage rod, and a connection point of the protection plate and the upper linkage rod is on the first fixing portion. The second fixing portion is rotatably connected with the middle linkage rod, and a connection point of the protection plate and the middle linkage rod is on the second fixing portion.

Furthermore, the fixing piece for the folding plate includes a fixing portion and a connection portion fixed together. The connection portion is perpendicular to the fixing portion, and the connection portion is rotatably connected with the upper linkage rod and the lower linkage rod respectively.

Furthermore, the middle linkage rod includes a first connection portion, a second connection portion and a second bending portion connecting the first connection portion and the second connection portion. The first connection portion is rotatably connected with the lower linkage rod, and a connection point of the middle linkage rod and the lower linkage rod is on the first connection portion; the second connection portion is rotatably connected with the second fixing portion and a connection point of the protection plate and the middle linkage rod is on the second connection portion.

Furthermore, the lower linkage rod includes a first mounting portion, a second mounting portion, and a body portion connecting the first mounting portion and the second mounting portion. The first mounting portion is rotatably connected with the middle linkage rod and the fixing piece for the folding plate respectively. The body portion is arc-shaped and protrudes away from the upper linkage rod. The second mounting portion is rotatably connected with the bottom of the fixing piece.

The present disclosure further provides a seating equipment, which includes a backrest assembly, a folding plate assembly, and the above backrest folding assembly. The fixing piece is fixedly connected with the backrest assembly, and the fixing piece for the folding plate is fixedly connected with the folding plate assembly.

Furthermore, when the backrest folding assembly is folded up, the upper linkage rod, the lower linkage rod, the fixing piece for the folding plate and the protection plate are folded up between the side plates of the backrest assembly and the folding plate assembly, and all are disposed in an inclination direction of the side plates.

Furthermore, when the backrest folding assembly is unfolded, an edge of the protection plate fits a front edge of the backrest assembly, and the protection plate and the backrest assembly jointly cover a gap formed by the fixing piece and the upper linkage rod.

In the present disclosure, with rotatable connection of the fixing piece, the upper linkage rod, the lower linkage rod, the middle linkage rod, the fixing piece for the folding plate and the protection plate, the backrest folding assembly can be folded and unfolded. In this way, the backrest folding assembly has fewer parts and lower manufacturing costs. Furthermore, by setting the middle linkage rod and the protection plate, protection is provided during a folding process of the backrest folding assembly, thereby improving use safety.

### BRIEF DESCRIPTION OF DRAWINGS

FIG. 1 is a front view illustrating a backrest folding assembly in an unfolded state according to the present disclosure.

FIG. 2 is a schematic diagram illustrating the backrest folding assembly of FIG. 1 in another view.

FIG. 3 is a side view illustrating the backrest folding assembly of FIG. 1.

FIG. 4 is a schematic diagram illustrating the backrest folding assembly of FIG. 1 without the protection plate.

FIG. 5 is a schematic diagram illustrating the backrest folding assembly of FIG. 1 in a folding process.

FIG. 6 is a front view illustrating a backrest folding assembly in a folded state according to the present disclosure.

FIG. 7 is a schematic diagram illustrating the backrest folding assembly of FIG. 6 in another view.

FIG. 8 is a side view illustrating the backrest folding assembly of FIG. 6.

FIG. 9 is a schematic diagram illustrating a lower linkage rod of the backrest folding assembly of FIG. 1.

FIG. 10 is a schematic diagram illustrating a fixing piece for a folding plate of the backrest folding assembly of FIG. 1.

FIG. 11 is a schematic diagram illustrating a middle linkage rod of the backrest folding assembly of FIG. 1.

FIG. 12 is a schematic diagram illustrating a protection plate of the backrest folding assembly of FIG. 1.

FIG. 13 is a schematic diagram illustrating a seating equipment with a folding plate in a folded state according to the present disclosure.

FIG. 14 is a schematic diagram illustrating a seating equipment with a folding plate in an unfolded state according to the present disclosure.

### REFERENCE SIGNS ARE DESCRIBED BELOW

100-backrest assembly, 101-side plate, 102-back plate, 103-accommodation space, 104-front edge, 200-folding plate assembly, 201-groove, 202-storage hole, 300-seating part, 10-fixing piece, 11-mounting hole, 12-first fixing hole, 13-second fixing hole, 20-upper linkage rod, 21-connection hole, 22-connection hole, 23-connection hole, 30-lower linkage rod, 31-first mounting portion, 311-first mounting hole, 312-second mounting hole, 32-body portion, 33-second mounting portion, 331-third mounting hole, 40-fixing piece for the folding plate, 41-fixing portion, 411-third fixing hole, 412-fourth fixing hole, 42-connection portion, 421-fourth mounting hole, 422-fifth mounting hole, 50-middle linkage rod, 51-first connection portion, 511-first through hole, 52-second connection portion, 521-second through hole, 53-second bending portion, 60-protection plate, 601-first fixing portion, 602-second fixing portion, 603-first bending portion, 604-third through hole, 605-fourth through hole, 61-top edge, 62-first side edge, 63-bottom edge, 64-second side edge, 70-connection point, 71-connection point, 72-connection point, 73-connection point, 74-connection point, 75-connection point, 76-connection point, and 77-connection point.

### DETAILED DESCRIPTION

Technical solutions of the embodiments (or called implementations) of the present disclosure will be fully and clearly described below in combination with the drawings. When the following descriptions involve drawings, same numerals in different drawings refer to same or similar elements unless otherwise stated.

If terms related to directional indications or positional relationships (such as upper, lower, left, right, front, rear, inner, outer, top, bottom, center, vertical, horizontal, longitudinal, transverse, length, width, counterclockwise, clockwise, axial, radial and circumferential and the like) are involved in the embodiments of the present disclosure, such terms are used only to explain a relative positional relationship and movement condition and the like of various parts under a specific pose (as shown in drawings). If the specific pose is changed, the directional indication or positional relationship can also be changed accordingly. Furthermore, terms “first” and “second” involved in the embodiments of the present disclosure are used only for ease of descriptions and shall not be understood as indicating or implying any relative importance.

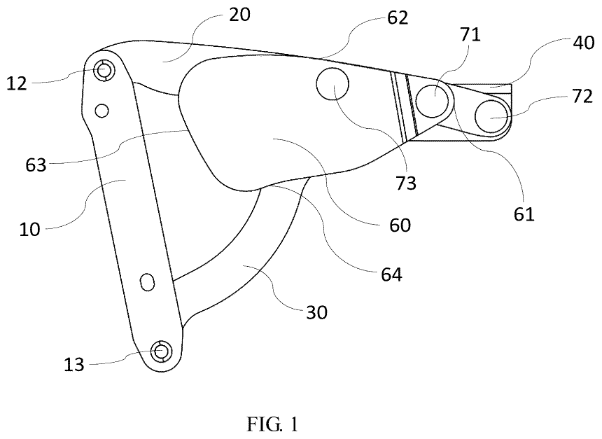

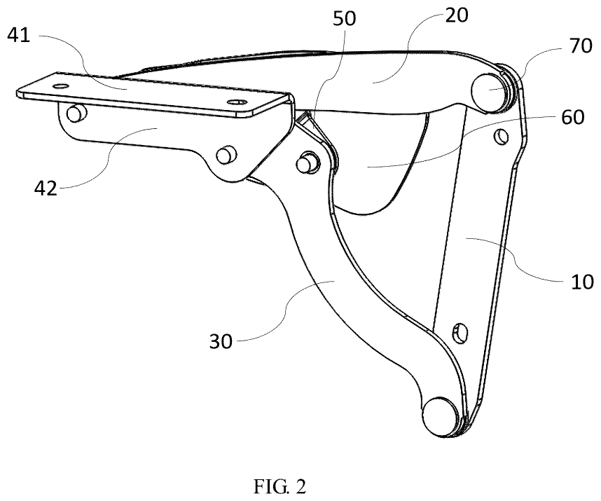

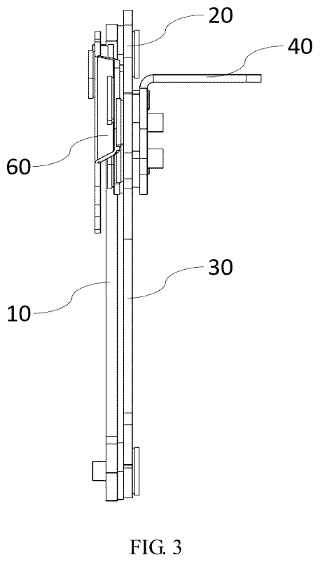

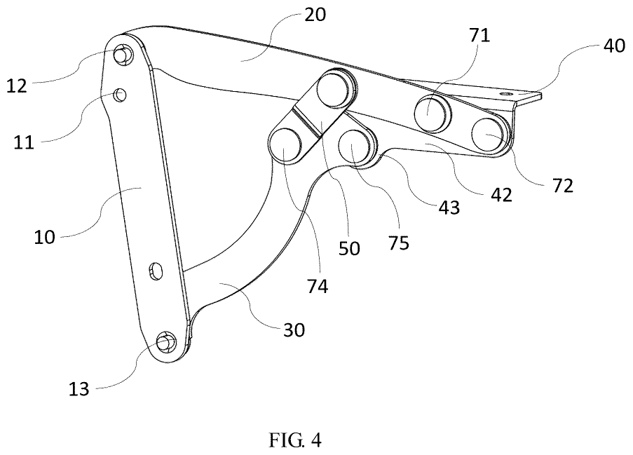

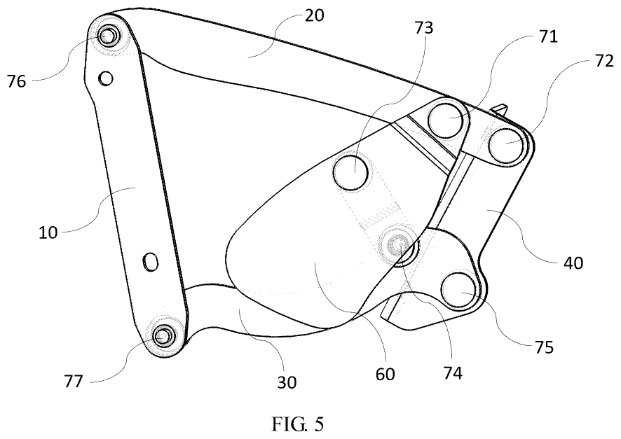

With reference to FIGS. 1 to 5, a backrest folding assembly includes a fixing piece 10, an upper linkage rod 20, a lower linkage rod 30, a fixing piece for a folding plate 40, a middle linkage rod 50 and a protection plate 60. An end of each of the upper linkage rod 20 and the lower linkage rod 30 is rotatably connected with the fixing piece 10 respectively, and the other end of each of the upper linkage rod 20 and the lower linkage rod 30 is rotatably connected with the fixing piece for the folding plate 40 respectively. The middle linkage rod 50 is rotatably connected with the lower linkage rod 30, and the protection plate 60 is rotatably connected with the upper linkage rod 20 and the middle linkage rod 50 respectively. A connection point 70 is formed among the fixing piece 10, the upper linkage rod 20, the lower linkage rod 30, the fixing piece for the folding plate 40, the middle linkage rod 50 and the protection plate 60.

The fixing piece 10 is shaped like a long straight rod, and a mounting hole 11 is provided on the fixing piece 10. There may be one or more mounting holes 11. When there is one mounting hole 11, the mounting hole 11 is required to be an elongated mounting hole to limit a position of the fixing piece 10. When there are several mounting holes 11, the mounting holes 11 may be round holes or a combination of round holes and elongated holes. A first fixing hole 12 and a second fixing hole 13 are respectively provided on a top and bottom of the fixing piece 10.

The upper linkage rod 20 is shaped like a long straight rod, and three connection holes 21, 22, 23 are provided on the upper linkage rod 20. The connection hole 21 and the connection hole 23 are respectively located on two ends of the upper linkage rod 20, and the connection hole 22 is between the connection hole 21 and the connection hole 23. A distance between the connection hole 22 and the connection hole 23 is less than a distance between the connection hole 21 and the connection hole 22. The upper linkage rod 20 is riveted to top of the fixing piece 10. The first fixing hole 12 is aligned with the connection hole 21, and a rivet is assembled into the first fixing hole 12 and the connection hole 21 to rivet the fixing piece 10 and the upper linkage rod 20.

The fixing piece 10 and the upper linkage rod 20 are both shaped like a long straight rod or shaped approximate to a long straight rod. In this case, when the backrest folding assembly is folded up, a gap and an included angle between the fixing piece 10 and the upper linkage rod 20 is small, thereby occupying small space. Furthermore, the fixing piece 10 and the upper linkage rod 20 can also be set as a curved linkage rod or arc-shaped linkage rod according to aesthetics or designing requirements.

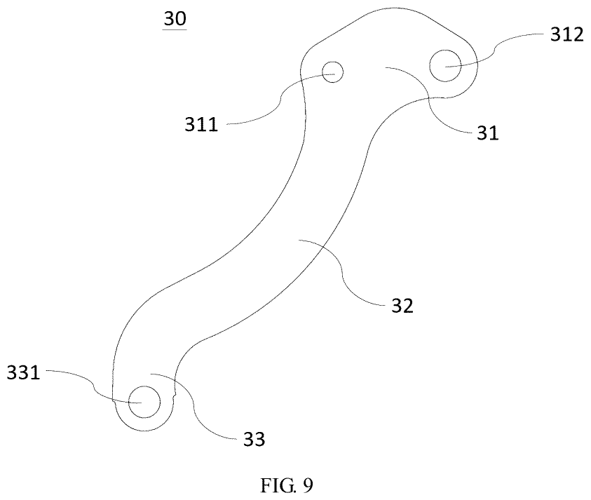

With reference to FIG. 9, the lower linkage rod 30 includes a first mounting portion 31, a second mounting portion 33, and a body portion 32 connecting the first mounting portion 31 and the second mounting portion 33. The body portion 32 is arc-shaped and protrudes in a direction away from the upper linkage rod 20. A first mounting hole 311 and a second mounting hole 312 are provided on the first mounting portion 31. A third mounting hole 331 is provided on the second mounting portion 33. The second fixing hole 13 is aligned with the third mounting hole 331, and a rivet is assembled into the second fixing hole 13 and the third mounting hole 331 to rivet the fixing piece 10 and the second mounting portion 33.

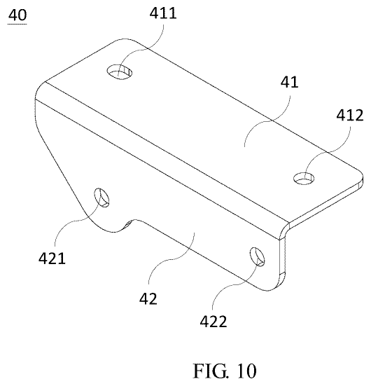

With reference to FIG. 10, the fixing piece for the folding plate 40 includes a fixing portion 41 and a connection portion 42 fixed together, and the connection portion 42 is perpendicular to the fixing portion 41. A third fixing hole 411 and a fourth fixing hole 412 are provided on the fixing portion 41. A fourth mounting hole 421 and a fifth mounting hole 422 are provided on the connection portion 42. The fourth mounting hole 421 is aligned with the second mounting hole 312. A rivet is assembled into the fourth mounting hole 421 and the second mounting hole 312 to fixedly rivet the connection portion 42 and the first mounting portion 31. The fifth mounting hole 422 is aligned with the connection hole 23, and a rivet is assembled into the fifth mounting hole 422 and the connection hole 23 to fixedly rivet the connection portion 42 and the upper linkage rod 20.

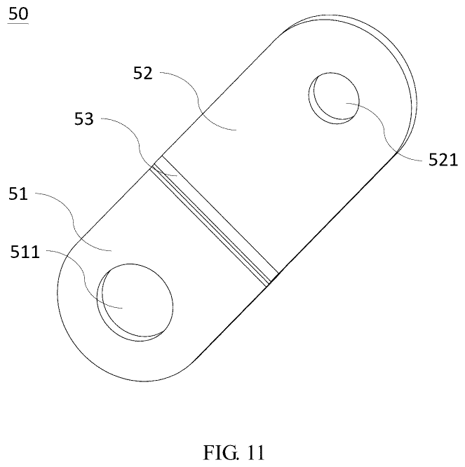

With reference to FIG. 11, the middle linkage rod 50 includes a first connection portion 51, a second connection portion 52 and a second bending portion 53 connecting the first connection portion 51 and the second connection portion 52. A first through hole 511 is provided on the first connection portion 51 and a second through hole 521 is provided on the second connection portion 52. The first through hole 511 is aligned with the first mounting hole 311. A rivet is assembled into the first through hole 511 and the first mounting hole 311 to rivet the first connection portion 51 and the first mounting portion 31. The second connection portion 52 is fixed to the protection plate 60.

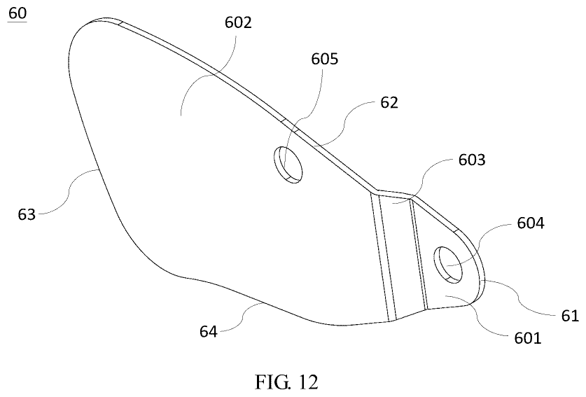

With reference to FIG. 12, the protection plate 60 includes a top edge 61, a first side edge 62, a bottom edge 63 and a second side edge 64 connected sequentially. The top edge 61 is opposed to the bottom edge 63, and the first side edge 62 is opposed to the second side edge 64. A length of the bottom edge 63 is greater than a length of the top edge 61. The first side edge 62 and the second side edge 64 are approximate in length and both have smooth curves.

The protection plate 60 includes a first fixing portion 601, a second fixing portion 602, and a first bending portion 603 connecting the first fixing portion 601 and the second fixing portion 602. A third through hole 604 is provided on the first fixing portion 601, and the third through hole 604 is aligned with the connection hole 22. A rivet is assembled into the third through hole 604 and the connection hole 22 to rivet the first fixing portion 601 and the upper linkage rod 20. A fourth through hole 605 is provided on the second fixing portion 602, and the fourth through hole 605 is aligned with the second through hole 521. A rivet is assembled into the fourth through hole 605 and the second through hole 521 to rivet the second fixing portion 602 and the second connection portion 52.

The protection plate 60 is provided with the first bending portion 603 such that, viewed from a side of the backrest folding assembly, the first fixing portion 601 and the second fixing portion 602 are in parallel and have a gap therebetween. When the backrest folding assembly is folded, the protection plate 60 will not rub against or collide with the rivet on the lower linkage rod 30, reducing noise and improving service life.

The connection point 70 includes a connection point 71, a connection point 72, a connection point 73, a connection point 74, a connection point 75, a connection point 76 and a connection point 77. The upper linkage rod 20 and the first fixing portion 601 are riveted to form the connection point 71. The upper linkage rod 20 and the connection portion 42 are riveted to form the connection point 72. The second fixing portion 602 and the second connection portion 52 are riveted to form the connection point 73. The first connection portion 51 and the first mounting portion 31 are riveted to form the connection point 74. The first mounting portion 31 and the connection portion 42 are riveted to form the connection point 75. The top of the fixing piece 10 and the upper linkage rod 20 are riveted to form the connection point 76. The bottom of the fixing piece 10 and the second mounting portion 33 are riveted to form the connection point 77.

The connection point 71 is close to the connection point 72. The connection point 73 is in the middle of the protection plate 60. A distance between the connection point 74 and the connection point 73 is close to a distance between the connection point 74 and the connection point 75. The connection point 72 and the connection point 75 are respectively located at both ends of the connection portion 42.

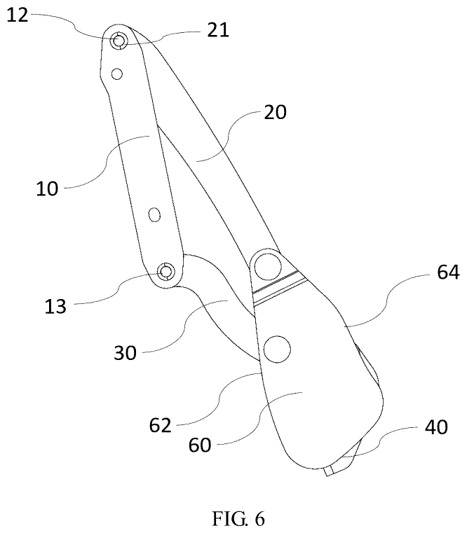

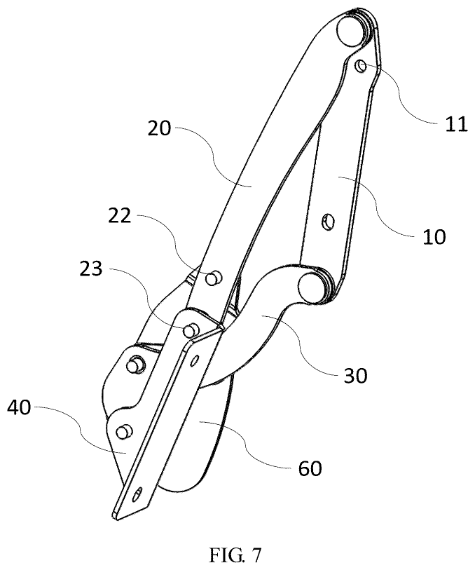

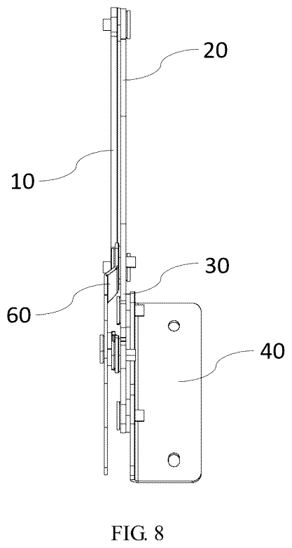

Referring to FIGS. 6 to 8 at the same time, when the backrest folding assembly is unfolded, bottoms of the fixing piece for the folding plate 40 and the protection plate 60 are lifted and moved close to the fixing piece 10, and tops of the fixing piece for the folding plate 40 and the protection plate 60 are lifted and moved away from the fixing piece 10. The first side edge 62 is flush with an upper edge of the upper linkage rod 20, and the second side edge 64 is below the upper linkage rod 20. A closet edge of the protection plate 60 to the fixing piece 10 is the bottom edge 63. The protection plate 60 covers an upper part of the lower linkage rod 30 (when in a state of FIG. 1). The first side edge 62 is flush with the upper edge of the upper linkage rod 20, which means that the first side edge 62 in the whole tends to be close to the upper edge of the upper linkage rod 20. In some implementations, the first side edge 62 may be slightly higher or lower than the upper edge of the upper linkage rod 20.

When the backrest folding assembly is folded up, the bottoms of the fixing piece for the folding plate 40 and the protection plate 60 are lowered and moved away from the fixing piece 10, and the tops of the fixing piece for the folding plate 40 and the protection plate 60 are lowered and moved close to the fixing piece 10. A closet edge of the protection plate 60 to the fixing piece 10 is the first side edge 62, and the first side edge 62 and the second side edge 64 are respectively located at both sides of the upper linkage rod 20. The protection plate 60 covers the fixing piece for the folding plate 40.

The fixing piece for the folding plate 40 and the protection plate 60 are always located before the fixing piece 10 during the folding process. The protection plate 60 is located at an inner (outer) side of the upper linkage rod 20 and the lower linkage rod 30, and the fixing piece for the folding plate 40 is located at an outer (inner) side of the upper linkage rod 20 and the lower linkage rod 30. The protection plate 60 and the fixing piece for the folding plate 40 are same in folding direction. When the backrest folding assembly is unfolded or folded, the protection plate 60 can cover a gap enclosed by the upper linkage rod 20, the lower linkage rod 30 and the fixing piece for the folding plate 40.

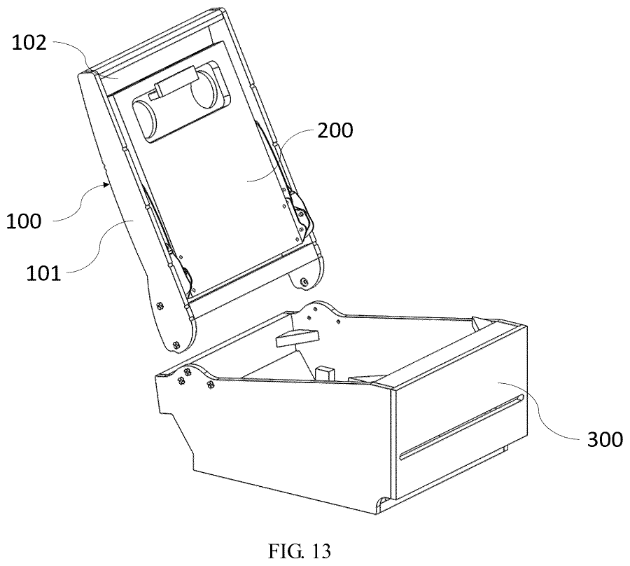

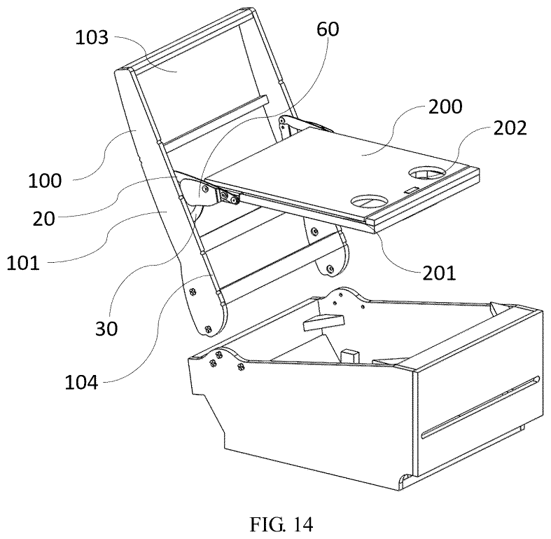

With reference to FIGS. 13 and 14, the present disclosure further provides a seating equipment, including a backrest assembly 100, a folding plate assembly 200, a seating part 300 and the above backrest folding assembly. The folding plate assembly 200 can be folded relative to the backrest assembly 100. The backrest assembly 100 is fixed to the seating part 300. The folding plate assembly 200 is located above the seating part 300. The fixing piece 10 is fixedly connected to the backrest assembly 100, and the fixing piece for the folding plate 40 is fixedly connected to the folding plate assembly 200.

The backrest assembly 100 includes two side plates 101 and a back plate 102. The two side plates 101 are arranged oppositely and both fixed to the back plate 102. The two side plates 101 and the back plate 102 are all enclosed to form an accommodation space 103. When the backrest folding assembly is folded up, the folding plate assembly 200 and a part of the backrest folding assembly are received in the accommodation space 103. The folding plate assembly 200 is parallel to front edges 104 of the side plates 101. The upper linkage rod 20, the lower linkage rod 30, the fixing piece for the folding plate 40 and the protection plate 60 are all disposed in an inclination direction of the side plates 101, that is, disposed in a length direction of the front edges 104. An inclination angle of the upper linkage rod 20, the lower linkage rod 30, the fixing piece for the folding plate 40 and the protection plate 60 in a folded state is close to an inclination angle of the side plates 101.

When the backrest folding assembly is unfolded, the folding plate assembly 200 and a part of the backrest folding assembly are protruded out of the accommodation space 103. The protection plate 60 is located before the side plate 101 (for example, in FIG. 14, a protrusion direction of the folding plate assembly 200 is a front side of the side plate 101). The bottom edge 63 fits the front edge 104. The protection plate 60 and the side plate 101 jointly cover a gap formed by the fixing piece 10 and the upper linkage rod 20. The protection plate 60 substantially covers a gap enclosed by the side plate 101, the upper linkage rod 20 and the lower linkage rod 30.

A groove 201 is opened on a side edge of the folding plate assembly 200, and the fixing portion 41 is inserted into the groove 201. A thickness of the fixing portion 41 is less than or equal to a width of the groove 201. A width of the connection portion 42 is less than or equal to a thickness of the folding plate assembly 200. The folding plate assembly 200 is provided with two storage holes 202. When the folding plate assembly 200 is unfolded, the storage holes 202 are provided for placing drinking cups or tea cups or the like. There may be one or more storage holes 202, and the storage holes 202 can also be disposed as through holes or semiclosed holes.

In the present disclosure, with the rotatable connection of the fixing piece 10, the upper linkage rod 20, the lower linkage rod 30, the middle linkage rod 50, the fixing piece for the folding plate 40 and the protection plate 60, the backrest folding assembly can be folded and unfolded. In this way, the backrest folding assembly has fewer parts and lower manufacturing costs. Furthermore, by setting the middle linkage rod 50 and the protection plate 60, protection is provided during a folding process of the backrest folding assembly, thereby avoiding pinching a user and improving use safety.

It should be noted that the technical solutions or technical features described in the above embodiments can be mutually combined or supplemented in case of no conflict. The scope of protection of the present disclosure is not limited to the precise structures described in the above embodiment and shown in the drawings. Any modifications, equivalent substitutions and improvements and the like made within the spirit and principle of the present disclosure shall fall within the scope of protection of the present disclosure.

What is claimed is:

1. A backrest folding assembly, comprising a fixing piece, an upper linkage rod, a lower linkage rod, a fixing piece for a folding plate, a middle linkage rod and a protection plate; wherein an end of each of the upper linkage rod and the lower linkage rod is rotatably connected with the fixing piece respectively, and the other end of each of the upper linkage rod and the lower linkage rod is rotatably connected with the fixing piece for the folding plate respectively; the middle linkage rod is rotatably connected with the lower linkage rod, and the protection plate is rotatably connected with the upper linkage rod and the middle linkage rod respectively.

2. The backrest folding assembly of claim 1, wherein the protection plate and the fixing piece for the folding plate are located at inner and outer sides of the upper linkage rod and the lower linkage rod respectively, and the protection plate and the fixing piece for the folding plate are same in folding direction.

3. The backrest folding assembly of claim 1, wherein when the backrest folding assembly is unfolded, bottoms of the fixing piece for the folding plate and the protection plate are lifted and moved close to the fixing piece, and tops of the fixing piece for the folding plate and the protection plate are lifted and moved away from the fixing piece.

4. The backrest folding assembly of claim 1, wherein the protection plate is constructed to cover a gap enclosed by the upper linkage rod, the lower linkage rod and the fixing piece for the folding plate when the backrest folding assembly is unfolded or folded.

5. The backrest folding assembly of claim 4, wherein the protection plate comprises a top edge, a first side edge, a bottom edge and a second side edge connected sequentially; the top edge is opposed to the bottom edge, and the first side edge is opposed to the second side edge; a length of the bottom edge is greater than a length of the top edge.

6. The backrest folding assembly of claim 5, wherein when the backrest folding assembly is unfolded, the first side edge is flush with an upper edge of the upper linkage rod; the second side edge is below the upper linkage rod; the bottom edge is located before the fixing piece; the protection plate covers an upper part of the lower linkage rod; when the backrest folding assembly is folded up, the first side edge is located before the fixing piece, and the first side edge and the second side edge are respectively located at both sides of the upper linkage rod; the protection plate covers the fixing piece for the folding plate.

7. The backrest folding assembly of claim 1, wherein the protection plate comprises a first fixing portion, a second fixing portion, and a first bending portion connecting the first fixing portion and the second fixing portion; the first fixing portion is rotatably connected to the upper linkage rod, and a connection point of the protection plate and the upper linkage rod is on the first fixing portion; the second fixing portion is rotatably connected with the middle linkage rod, and a connection point of the protection plate and the middle linkage rod is on the second fixing portion.

8. The backrest folding assembly of claim 1, wherein the fixing piece for the folding plate comprises a fixing portion and a connection portion fixed together; the connection portion is perpendicular to the fixing portion, and the connection portion is rotatably connected with the upper linkage rod and the lower linkage rod respectively.

9. The backrest folding assembly of claim 7, wherein the middle linkage rod comprises a first connection portion, a second connection portion and a second bending portion connecting the first connection portion and the second connection portion; the first connection portion is rotatably connected with the lower linkage rod, and a connection point of the middle linkage rod and the lower linkage rod is on the first connection portion; the second connection portion is rotatably connected with the second fixing portion and a connection point of the protection plate and the middle linkage rod is on the second connection portion.

10. The backrest folding assembly of claim 1, wherein the lower linkage rod comprises a first mounting portion, a second mounting portion, and a body portion connecting the first mounting portion and the second mounting portion; the first mounting portion is rotatably connected with the middle linkage rod and the fixing piece for the folding plate respectively; the body portion is arc-shaped and protrudes away from the upper linkage rod; the second mounting portion is rotatably connected with the bottom of the fixing piece.

11. A seating equipment, comprising a backrest assembly, a folding plate assembly, and a backrest folding assembly, wherein the fixing piece is fixedly connected with the backrest assembly, and the fixing piece for the folding plate is fixedly connected with the folding plate assembly, the backrest folding assembly, comprising:
a fixing piece, an upper linkage rod, a lower linkage rod, a fixing piece for a folding plate, a middle linkage rod and a protection plate; wherein an end of each of the upper linkage rod and the lower linkage rod is rotatably connected with the fixing piece respectively, and the other end of each of the upper linkage rod and the lower linkage rod is rotatably connected with the fixing piece for the folding plate respectively; the middle linkage rod is rotatably connected with the lower linkage rod, and the protection plate is rotatably connected with the upper linkage rod and the middle linkage rod respectively.

12. The seating equipment of claim 11, wherein when the backrest folding assembly is folded up, the upper linkage rod, the lower linkage rod, the fixing piece for the folding plate and the protection plate are folded up between side plates of the backrest assembly and the folding plate assembly, and all are disposed in an inclination direction of the side plates.

13. The seating equipment of claim 12, wherein when the backrest folding assembly is unfolded, an edge of the protection plate fits a front edge of the backrest assembly, and the protection plate and the backrest assembly jointly cover a gap formed by the fixing piece and the upper linkage rod.
